(19) United States
(12) Patent Application Publication
(10) Pub. No.: US 2008/0147903 A1
(43) Pub. Date: Jun. 19, 2008

(54) Method and Apparatus for Implementing Commands in Input/Output (IO) Hub

(76) Inventor: Paul Gregory Curtis, Rochester, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/548,420

(22) Filed: Oct. 11, 2006

(51) Int. Cl. G06F 13/28

(52) U.S. Cl. 710/22

(57) ABSTRACT

Method and apparatus implementing commands in an input/output (IO) hub includes a programmable command generator having an input coupled to an external interface and an output providing commands. The programmable command generator selectively couples commands in a path between a front end of the IO hub and an IO hub logic address and command routing output.

### FIELD OF THE INVENTION

The present invention relates generally to the data processing field and a programmable command generator, and more particularly, relates to a method and apparatus for implementing commands with a programmable command generator provided within an input/output (IO) hub.

### DESCRIPTION OF THE RELATED ART

IO hubs and bridges often are required to route multiple different command types, such as memory mapped addresses, interrupts, coherency, and the like, from a processor bus to multiple different locations. Memory mapped addresses may pass through several address decodes in the IO hub and bridge before reaching their final destination.

When addressing or routing issues inevitably arise beneath the IO hub in a lab environment, it can be very difficult to recreate the problem. This results because the IO hub is a slave to all operations directed by the processor. Therefore there may be a lot of overhead required to generate the command sequence causing the fail. This typically means that software needs updates to trap on the error, if an ideal trap is even possible.

A need exists for a mechanism for more effectively and efficiently performing 10 operations.

### SUMMARY OF THE INVENTION

A principal aspect of the present invention is to provide a method and apparatus for implementing commands in an input/output (IO) hub. Other important aspects of the present invention are to provide such method and apparatus for implementing commands in an input/output (IO) hub substantially without negative effect and that overcome many of the disadvantages of prior art arrangements.

In brief, a method and apparatus are provided for implementing commands in an input/output (IO) hub. The IO hub includes a programmable command generator having an input coupled to an external interface and an output providing commands. The programmable command generator selectively couples commands in a path between a front end of the IO hub and an IO hub logic address and command routing output.

In accordance with features of the invention, a multiplexer is provided in the path between the front end of the IO hub and the IO hub logic address and command routing output and has an input connected to the output of the programmable command generator. A multiplexer select is applied to the multiplexer to select between normal operation of the IO hub and commands from the programmable command generator.

In accordance with features of the invention, the programmable command generator provides at least one predefined command type that is address programmable. The predefined command type includes a command type supported by a processor bus connected to the front end of the IO hub. The programmable command generator enables identifying bad machine path verification. The programmable command generator enables injecting errors on a single, directly controllable command, or data, allowing much more robust bad machine path verification in a lab environment.

In accordance with features of the invention, the programmable command generator enables independent control of the IO hub, without requiring software or processor communication overhead. The programmable command generator provides commands enabling initial bring up of devices coupled to the output of the IO hub. The programmable command generator provides the type of control needed to debug or easily recreate typical initial bring up problems.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating an input/output (IO) hub with a programmable command generator in accordance with the preferred embodiment.

### DETAILED DESCRIPTION OF THE PREFERRED EMBODIMENTS

In accordance with features of the invention, a programmable command generator is added to the front end of the IO hub. The programmable command generator is able to generate any type of command supported by an associated processor bus. The command generator is command type and address programmable, and would also include error injection. The generator advantageously is programmed by an existing external interface, such as JTAG or I2C.

In accordance with features of the invention, an enhanced IO hub including the command generator is enabled to generate its own commands, instead of depending on the processor and software. A self-contained programmable command generator in the IO hub allows the user to generate commands, such as a failing command with much less overhead than a conventional arrangement where the failing command is generated by an associated processor. This enables independent control of the IO hub, requiring no software or processor communication overhead.

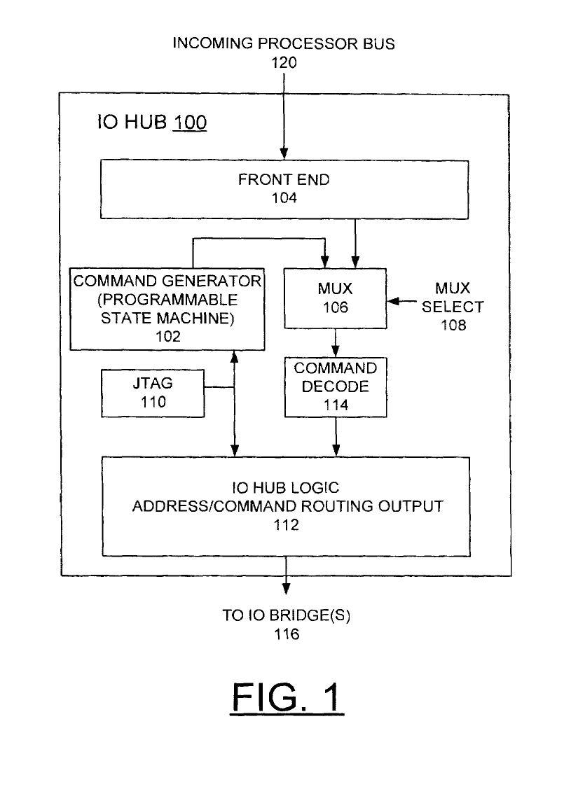

Having reference now to the drawings, in FIG. 1, there is shown an input/output (IO) hub generally designated by the reference character 100 in accordance with the preferred embodiment. IO hub 100 includes a programmable command generator 102 in accordance with the preferred embodiment.

A front end 104 of the IO hub 100 is connected to an input of a two-input multiplexer (MUX) 106. The programmable command generator 102 is connected to another input of a two-input multiplexer (MUX) 106. A multiplexer select input MUX SELECT 108 is applied to the multiplexer 106 to select between normal operation of the IO hub 100 and commands from the programmable command generator 102.

The programmable command generator 102 has an input coupled to an external interface, such as JTAG function 110, as shown. Alternatively an I2C external interface can be connected to the input of the programmable command generator 102. The JTAG function 110 is connected between the programmable command generator 102 and an IO hub logic address and command routing output 112.

An output of the programmable command generator 102 provides commands applied to MUX 106. A command decode 114 is connected to the output of MUX 106 and to the IO hub logic address and command routing output 112. The IO hub logic address and command routing output 112 of the IO hub is connected to one or more IO bridges 116. An incoming processor bus 120 is connected to the front end of the IO hub 104.

The programmable command generator 102 selectively couples commands in a path between the front end of the IO hub 104 and the IO hub logic address and command routing output 112. The programmable command generator 102 enables independent control of the IO hub 100.

A state machine and registers, which present command packets in the same format, as delivered from the front end logic 104 implement the command generator 102. Registers contained in command generator 102 are provided for command and address/data selection, as well as error injections. The programmable command generator 102 provides a register bit to select between normal operation and artificial command generation that is applied to the input MUX SELECT 108.

While the present invention has been described with reference to the details of the embodiments of the invention shown in the drawing, these details are not intended to limit the scope of the invention as claimed in the appended claims.

What is claimed is:

1. Apparatus for implementing commands in an input/output (IO) hub comprising:
said IO hub including a front end of the IO hub and a IO hub logic address and command routing output
a programmable command generator having an input coupled to an external interface and an output providing commands;
said programmable command generator selectively coupling commands in a path between said front end of the IO hub and said IO hub logic address and command routing output.

2. Apparatus for implementing commands as recited in claim 1 includes a multiplexer provided in the path between the front end of the IO hub and the IO hub logic address and command routing output; said multiplexer having an input connected to the output of said programmable command generator.

3. Apparatus for implementing commands as recited in claim 2 further includes a multiplexer select input applied to the multiplexer to select between normal operation of the IO hub and commands from said programmable command generator.

4. Apparatus for implementing commands as recited in claim 1 wherein said programmable command generator provides at least one predefined command type that is address programmable.

5. Apparatus for implementing commands as recited in claim 4 wherein said predefined command type includes a command type supported by a processor bus connected to the front end of the IO hub.

6. Apparatus for implementing commands as recited in claim 1 wherein said programmable command generator enables identifying bad machine path verification.

7. Apparatus for implementing commands as recited in claim 1 wherein said programmable command generator enables injecting errors on a single, directly controllable command.

8. Apparatus for implementing commands as recited in claim 1 wherein said programmable command generator enables independent control of the IO hub, without requiring software or processor communication overhead.

9. Apparatus for implementing commands as recited in claim 1 wherein said programmable command generator provides commands enabling initial bring up of devices coupled to the output of the IO hub.

10. Apparatus for implementing commands as recited in claim 1 wherein said programmable command generator provides control to debug initial bring up problems.

11. A method for implementing commands in an input/output (IO) hub, said IO hub including a front end of the IO hub and a IO hub logic address and command routing output, said method comprising the steps of:
providing a programmable command generator having an input coupled to an external interface and an output providing commands;
selectively coupling commands from said programmable command generator in a path between said front end of the IO hub and said IO hub logic address and command routing output.

12. A method for implementing commands in an input/output (IO) hub as recited in claim 11 includes providing a multiplexer in the path between the front end of the IO hub and the IO hub logic address and command routing output; said multiplexer having an input connected to the output of said programmable command generator.

13. A method for implementing commands in an input/output (IO) hub as recited in claim 12 includes providing a multiplexer select input applied to the multiplexer to select between normal operation of the IO hub and commands from said programmable command generator.

14. A method for implementing commands in an input/output (IO) hub as recited in claim 11 includes providing at least one predefined command type that is address programmable with said programmable command generator.

15. A method for implementing commands in an input/output (IO) hub as recited in claim 14 includes providing said predefined command type of a command type supported by a processor bus connected to the front end of the IO hub.

16. A method for implementing commands in an input/output (IO) hub as recited in claim 11 includes using said programmable command generator for identifying bad machine path verification.

17. A method for implementing commands in an input/output (IO) hub as recited in claim 11 includes using said programmable command generator for injecting errors on a single, directly controllable command.

18. A method for implementing commands in an input/output (IO) hub as recited in claim 11 includes using said programmable command generator to enable independent control of the IO hub, without requiring software or processor communication overhead.

19. A method for implementing commands in an input/output (IO) hub as recited in claim 11 includes using said programmable command generator for providing commands enabling initial bring up of devices coupled to the output of the IO hub.
